(19) United States
(12) Patent Application Publication
(10) Pub. No.: US 2026/0072218 A1
(43) Pub. Date: Mar. 12, 2026

(54) Manufacturable High Port Count Optical Cross Connect

(71) Applicant: Ciena Corporation, Hanover, MD (US)

(72) Inventors: David W. Boertjes, Nepean (CA); Daniel Rivaud, Ottawa (CA); Michael Y. Frankel, Hallandale Beach, FL (US); Vladimir Pelekhaty, Baltimore, MD (US); Fabien Colton, Kars (CA)

(73) Assignee: Ciena Corporation, Hanover, MD (US)

(21) Appl. No.: 18/829,551

(22) Filed: Sep. 10, 2024

(51) Int. Cl. G02B 6/35; G02B 6/26

(52) U.S. Cl. CPC G02B 6/359; G02B 6/262

(57) ABSTRACT

A modular and manufacturable optical cross connect includes a plurality of subassemblies each including either of an array of collimators and an array of adjustable mirrors, wherein the plurality of subassemblies are configured to modularly scale a size of the optical cross connect, wherein the plurality of subassemblies are arranged relative to one another with an optical propagation region in between, and wherein the plurality of subassemblies with the array of collimators each include one or more probe ports configured to support an alignment signal for active alignment control.

### FIELD OF THE DISCLOSURE

The present disclosure relates generally to networking and computing. More particularly, the present disclosure relates to systems and methods for a manufacturable high port count optical cross connect.

### BACKGROUND OF THE DISCLOSURE

An optical cross connect system is a device that routes optical signals directly between incoming and outgoing optical fibers (ports) without converting them to electrical signals. Essentially, it functions as a high-speed switch for light paths. Note, as is known in the art and as is described herein, an optical cross connect can also be referred to as an Optical Circuit Switch (OCS) and can be abbreviated as OXC or OCS. With the proliferation of Machine Learning (ML) and Artificial Intelligence (AI), data centers are exploding in terms of their compute power, leading to a significant increase in the interconnect between resources. An OCS is a key component and there is a need to scale such devices to 1000s of ports or more. However, there are issues with scale and cost of such devices, namely it is not cost effective to deploy a large OCS initially, i.e., one at full capacity, as well as reliability concerns of large devices, becoming single points of failure. There is a need for an OCS which supports modularity, redundancy, mass manufacturability, and high radix with low loss.

### BRIEF SUMMARY OF THE DISCLOSURE

The present disclosure relates to systems and methods for manufacturable high port count optical cross connect, such as for use in data center applications and the like. In particular, the present disclosure includes a Micro-Electro-Mechanical Systems (MEMS) design with contemplated port scale in the thousands with a modular subcomponent design that includes redundancy for yield improvement, manufacturability, and service. Specifically, the approach described herein supports an ability to scale port count, in-service, alleviating the need to deploy at full-fill. Further, the approach includes an active alignment technique via dedicated elements in the device, to improve stability and support calibration.

In an embodiment, an optical cross connect includes a plurality of subassemblies each including either an array of collimators and an array of adjustable mirrors, wherein the plurality of subassemblies are configured to modularly scale a size of the optical cross connect, wherein the plurality of subassemblies are arranged relative to one another with an optical propagation region in between, and wherein the plurality of subassemblies with the array of collimators each include one or more probe ports configured to support an alignment signal for active alignment control. Each of the plurality of subassemblies with the array of adjustable mirrors can include one or more detectors included in the array of adjustable mirrors, in lieu of a corresponding adjustable mirror. Each of the plurality of subassemblies can include a housing supporting either the array of collimators and the array of adjustable mirrors, and the housing includes electrical connectors to the array of adjustable mirrors and optical connections to the array of collimators. The housing supporting the array of collimators includes circuitry for physically alignment adjustments.

The plurality of subassemblies can include a first set of subassemblies and a second set of subassemblies opposing the first set of subassemblies with the optical propagation region in between. An overall size of the optical cross connect is based on a number of the plurality of subassemblies. The number of adjustable mirrors can include redundancy where some of the adjustable mirrors are unused. The plurality of subassemblies can include a first set of subassemblies and a second set of subassemblies opposing the first set of subassemblies with the optical propagation region in between and with a fixed set of mirrors in the optical propagation region. Each subassembly of the plurality of subassemblies includes a front portion having either the array of collimators and the array of mirrors thereon. The active alignment control includes compensating for angular alignment between two different subassemblies each with the array of mirrors, such that tilt angles support an acceptable loss between two collimators. The one or more probe ports can include at least three ports at edges of the array of collimators.

The active alignment control can include a laser connected to a probe port on a first array of collimators and configured to transmit the alignment signal; a receiver connected to a probe port on a second array of collimators and configured to receive the alignment signal, after the alignment signal traverse a pair of mirrors; and circuitry configured to measure angular offsets of the pair of mirrors. The circuitry can be further configured to apply a dither to the pair of mirrors, measure the alignment signal at the receiver over time based on the dither, and determine feedback for the pair of mirrors based on the measured alignment signal. The circuitry can be further configured to measure the angular offsets of the pair of mirrors in two different arrays of adjustable mirrors, and cause adjustment of all mirrors in the two different arrays of adjustable mirrors based on the measured angular offsets of the pair of mirrors. The size of the optical cross connect can be at least 1000 ports.

In another embodiment, a method of aligning an optical cross connect includes steps of, in the optical cross connect that includes a plurality of arrays with each array including one or more of collimators and adjustable mirrors, transmitting an alignment signal from an input probe port on an input array of collimators to a first mirror probe port on a first mirror array; directing the alignment signal from the first mirror port to a second mirror probe port on a second mirror array; and receiving and measuring the alignment signal on an output probe port on an output array. The can steps further include compensating for angular alignment of mirrors on the first mirror array and the second mirror array based on the measuring. The steps can further include applying a dither to the first mirror port and the second mirror port; measuring the alignment signal over time based on the dither; and determining feedback for mirrors on the first mirror array and the second mirror array based on the measured alignment signal. The steps can further include measuring angular offsets of first mirror probe port and the second mirror probe port; and causing adjustment of all mirrors in the first mirror array and the second mirror array based on the measured angular offsets. The input array of collimators and the output array of collimators can each include at least three ports at edge collimators.

### BRIEF DESCRIPTION OF THE DRAWINGS

The present disclosure is detailed through various drawings, where like components or steps are indicated by identical reference numbers for clarity and consistency.

FIG. 1 is a front view of a subassembly illustrating a front portion having traffic ports/mirrors and probe ports/mirrors.

FIG. 2 is a perspective view of the subassembly illustrating a housing connected to the front portion.

FIG. 3 is a front view of multiple subassemblies forming a portion of an optical cross connect.

FIG. 4 is a perspective view of the multiple subassemblies together in the optical cross connect.

FIG. 5 is a top view of the optical propagation region between the multiple subassemblies in FIG. 4 with two ports shown opposing one another.

FIG. 6 is a close-up view of one end of the OCS showing one layer in the 2D stack of input/output and mirror elements.

FIG. 7 is a logical diagram illustrating an example connection from an input array, to a first mirror array, to a second mirror array, to an output array.

FIG. 8 is a graph of the transmission coefficient of the signal path depending on the alignment angle of each axis of each mirror.

FIG. 9 is a graph of a sinusoidal dither applied to the axes of the mirrors.

FIG. 10 is a graph of the transmission coefficient indicating which direction the correction for misalignment should be.

FIG. 11 is a graph of a Fast Fourier transform (FFT) of the signals in FIG. 10.

FIG. 12 is a graph of points corresponding to the average power (so called DC or zeroth frequency point in the FFT), the fundamental (the frequency of the dither) and the second harmonic (2× the frequency of the dither), from the FFT of FIG. 11.

FIG. 13 is a diagram of a periscopic arrangement of collimators and mirrors.

FIG. 14 is a diagram of a compact arrangement of collimators and mirrors.

FIGS. 15 and 16 are diagrams of dense packing of collimators.

FIGS. 17 and 18 are graphs of vertical and horizontal angular deviation of beams for the hexagonal grid in FIG. 16.

FIGS. 19 and 20 are graphs of coupling efficiency of 1320 nm light in confocal pair of diameter 2.0 mm focusers at 640 mm versus deviations d1 and d2 from prescribed distance between fiber faces and lenses.

FIGS. 21 and 22 are graphs of coupling efficiency of 1320 nm light in pair of diameter 2.0 mm collimators at 640 mm versus deviations d1 and d2 from prescribed distance between fiber faces and lenses.

FIGS. 23 and 24 are graphs of coupling efficiency of two 1320 nm Gaussian beams with wₒ=3 μm versus lateral displacement (FIG. 23) and angular misalignment (FIG. 24).

FIG. 25 is a flowchart of a process of aligning an optical cross connect.

FIGS. 26-28 illustrates three different arrangements of input/output arrays, MEMS arrays, and fixed mirrors, arranged relative to one another with the optical propagation region.

FIG. 29 is a front view of the subassembly illustrating a front portion having MEMs mirrors and a quad detector.

FIG. 30 is a diagram of an example arrangement of the MSM quadrant detector design.

FIG. 31 is another arrangement with four quadrant detectors at four corners of the matrix effectively forming a large, distributed quadrant PD.

FIGS. 32-49 are diagrams of an example form factor for a subassembly with ports for the input/output array, where the form factor includes alignment circuitry configured to align/adjust the front portion based on the quadrant detector feedback.

### DETAILED DESCRIPTION OF THE DISCLOSURE

Again, the present disclosure relates to systems and methods for manufacturable high port count optical cross connect, such as for use in data center applications and the like. Of note, conventional OCS which use MEMS mirrors are limited in scale due to yield and optomechanical considerations. See, e.g., Urata, Ryohei, et al. “Mission Apollo: landing optical circuit switching at datacenter scale.” arXiv preprint arXiv: 2208.10041 (2022), the contents of which are incorporated by reference. The main limitation is the application of passive alignment performed once at start of life (i.e., initial manufacturing, configuration, etc.). This requires a very stiff and stable optical setup typically referred to as an optical bench. This is a very limiting factor both in terms of the size of the device that can be manufactured, and the volume of propagation area that is used which must be above the surface of the bench. These switches are currently limited to a few hundred ports at most.

Active alignment has been shown on free space optical devices but is applied to each port carrying traffic signals. This requires additional optical components for tapping light on the input and output so that the alignment can be measured. Since this is done on each port, this is not practical for high port count devices and also has the disadvantage of imparting an amplitude dither to the signal being carried. This dither can cause problems with the receiver control loops and eat into the link margin of the channel both of which are undesirable. Active alignment involves the precise positioning and alignment of optical components relative to the switch to ensure optimal light path management and signal integrity.

The design of this OCS overcomes the limitations of optical bench technology by applying a novel approach to active alignment. This approach uses smaller arrays of elements which have a high degree of mechanical stability in the plane substantially perpendicular to the direction of light propagation. Where the optical bench must also provide stability in the direction of propagation, this restriction is eliminated from this design through active control. This control uses dedicated probe paths to measure the relative alignment of the planes of the subcomponents in order to compensate for misalignment. This compensation is done through adding or subtracting in the correct proportions from the angles each sub element of the components to correct for the angles of the plane in real time. This control system will be discussed later in this section. The existence of this active alignment is advantageously used to simplify the design of the optical components. In particular, we separate the input, output, and multiple mirror planes into subassemblies that can be manufactured, yielded, and assembled independently. This could also allow for servicing a failed subcomponent without destroying the overall OCS which cannot be done with previous generations.

### Component Design

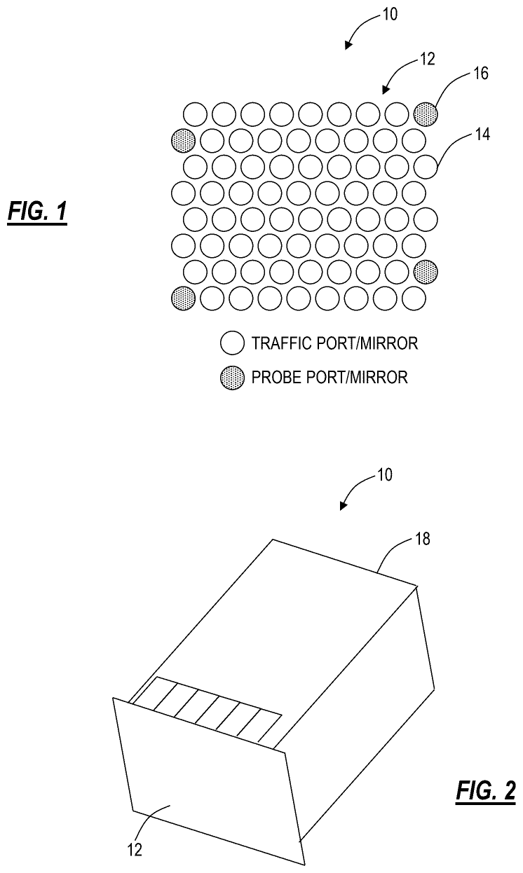

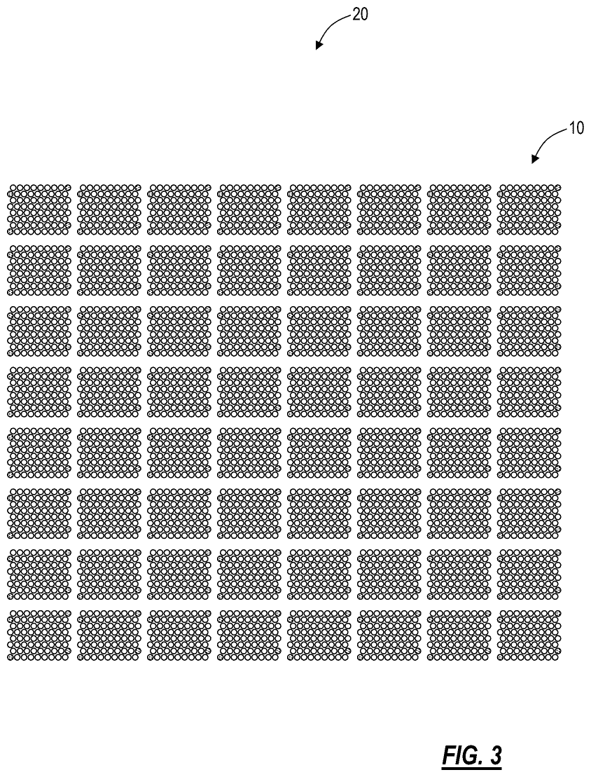

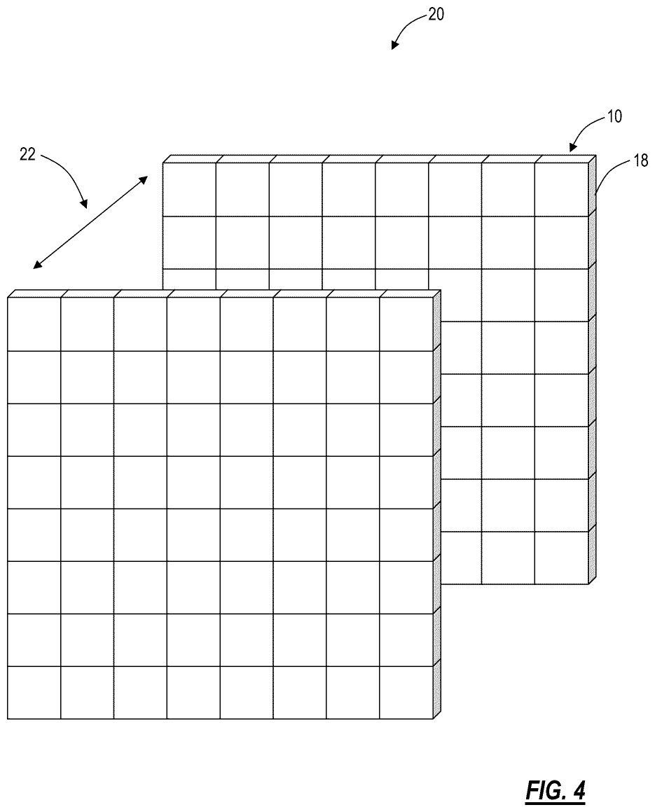

FIG. 1 is a front view of a subassembly 10 illustrating a front portion 12 having traffic ports/mirrors 14 and probe ports/mirrors 16. FIG. 2 is a perspective view of the subassembly 10 illustrating a housing 18 connected to the front portion 12. FIG. 3 is a front view of multiple subassemblies 10 forming a portion of an optical cross connect 20. FIG. 4 is a perspective view of the multiple subassemblies 10 together in the optical cross connect 20. Also, the following descriptions utilize example numbers in terms of ports, subassemblies 10, switch size, dimensions, etc., and those skilled in the art will appreciate this is for illustration purposes and the modularity of the subassembly 10 to build larger optical cross connects 20 contemplates various values, all of which are contemplated herewith.

The subassembly 10 includes a two-dimensional (2D) MEMS mirror array as a component used to build larger optical cross connects 20. Anticipating some degree of failure or misalignment in the components, redundancy during manufacturing is advantageous. For example, 68 element 2D arrays of MEMS mirrors are shown in FIGS. 1-2, e.g., which could be a good building block. If one plans on using the best 64 mirrors, then coupling this with a modular 68 collimator structure would be advantageous. Both have individual mirrors or collimators (e.g., Gradient Index (GRIN) lenses or microlens arrays) having a diameter of approximately 1.8 mm and can be mounted on approximately 2 mm pitch, as shown on the front portion 12. It would be beneficial to increase the mirror/port count slightly to include alignment paths as in the control system design described later herein. One would also like to have a flexible step in manufacturing where the best 64 fibers can be arranged in a splice holder to connect to multifiber connectors like Multi-fiber Push On (MPOs) or others such that all fibers in the connector are active under all successful subassemblies 10. In this example, there are 68 ports 14, 16, with four being designated as probes, and 64 for traffic ports.

As in FIG. 2, each subassembly 10 of collimators or mirrors could be individually connectorized and placed in the housing 18 providing a rugged element for assembly or repair. The housing 18 can utilize a cassette structure where cassettes could then be assembled into an array in a mechanical housing designed for the size of OCS 20 being manufactured.

As in FIGS. 3-4, Each 64-element subassembly 10 could be arranged as a subcomponent. A frame (not shown) could be provided where the subassemblies 10 are connected, in one or two dimensions to form a building block of a 4096-port input stage, assembled in a plane as shown in FIG. 3. For example, the front portion in FIG. 3 could be about 160×135 mm in dimension. Again, FIGS. 3-4 shown an example of a 4096-port switch, but larger or smaller sizes could also be contemplated. Specifically, the variables here include

(1) the traffic ports 14 in a subassembly 10, e.g., 64 in this example.

(2) the number of subassemblies 10 in the frame, e.g., 8×8=64 in this example.

This leads to a 4096-port switch. As in FIGS. 3-4, the MEMS arrays are assembled similarly on the opposite side of the frame in an array corresponding to the input elements arrangement. That is, the collection of subassemblies can be referred to as an array and there are two opposing arrays forming the optical cross connect 20. There is an optical propagation region 22 between two adjacent sets of subassemblies 10. The optical connections and electrical connections are disposed to the outside of the optical propagation region 22, i.e., inside the housing 18. These connections can be pre-connectorized at the subassembly 10 manufacture stage. In this example, a set of 64 subassemblies 10 completes one input or output.

Note, in FIG. 4, the optical cross connect 20 is formed by two opposing arrays. This can be viewed as a so-called “N” shape where the two horizontal lines in the “N” represent the arrays and the diagonal line representing the optical propagation region 22. Other embodiments are contemplated, such as a so-called “W” shape with a fixed set of mirrors in the optical propagation region 22 which is represented by the two middle diagonal lines in the “W” which come together at the fixed mirror. The present disclosure contemplates any arrangement of the two opposing arrays, i.e., they can be said to be relative to one another, whether opposing one another directly or indirectly via fixed mirrors, and the like.

For example, with the “W” shape, the front portion 12 of the assembly 10 can be said to either have ports 14 or mirrors 14. That is, there can be two different physical form factors for the subassembly 10, namely one with the ports 14, forming the input/output to the optical cross connect 20, and one with the mirrors 14, forming intermediate stages for switching light between the input/output assemblies 12 with the ports 14. There can further be a fixed array of mirrors in the optical propagation region 22.

With the “N” shape, the two opposing arrays can include different subassemblies, mixing ones with ports 14 and ones with mirrors 14, such as in FIG. 4. Further, those skilled in the art will recognize the present disclosure contemplates various different arrangements of the subassemblies 10 with their modularity and their active alignment ability.

### Piecewise Curved Arrays

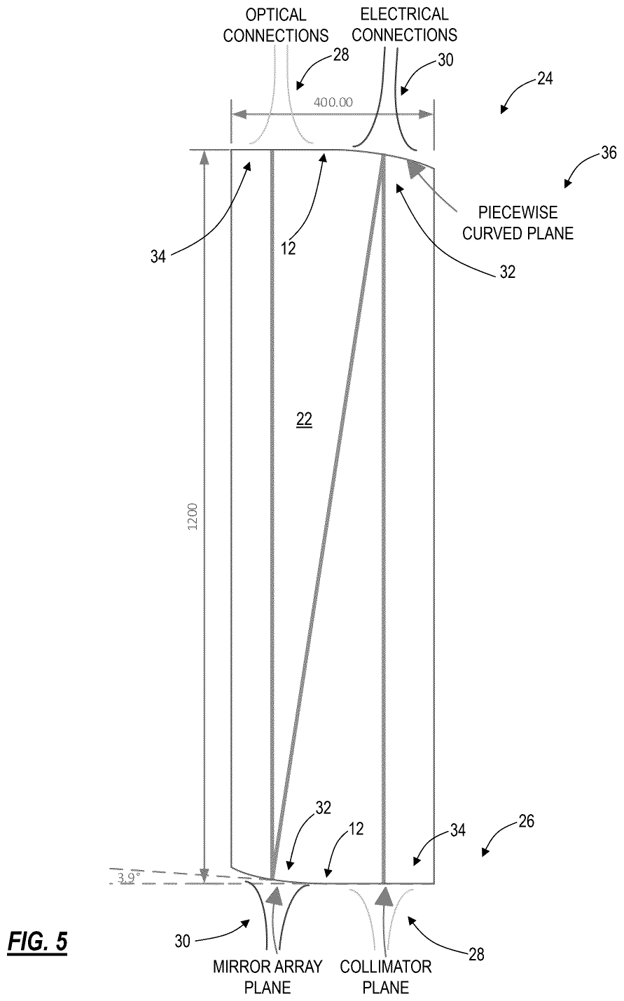

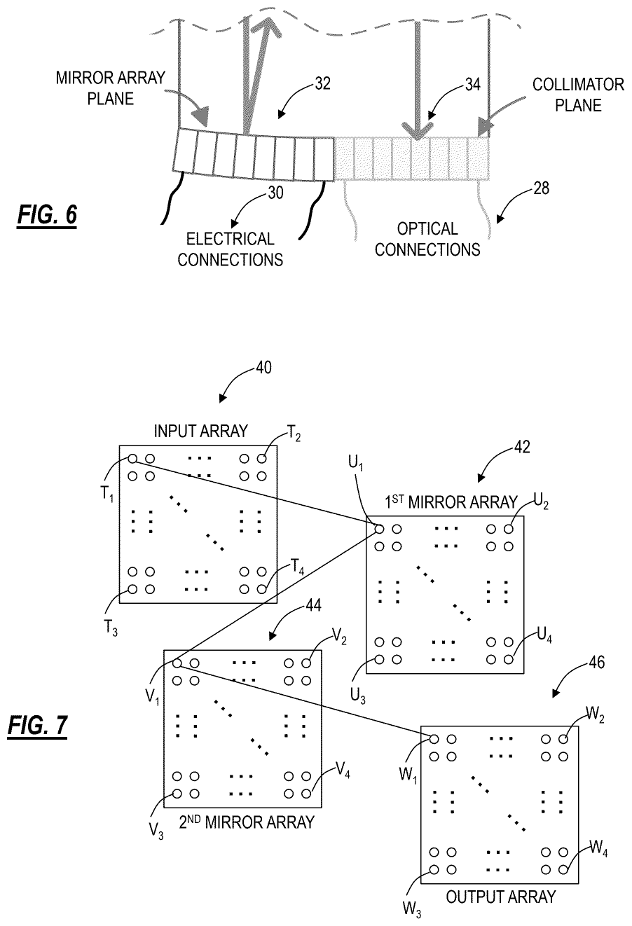

FIG. 5 is a top view on the optical propagation region 22 with two ports 24, 26 shown opposing one another. FIG. 5 also illustrates optical connections 28 and electrical connections 30 which can be disposed in the housing 18, behind the front portion 12. The front portion 12 includes a mirror array plane 32 and a collimator plane 34. Each port 24, 26 includes both the mirror array plane 32 and the collimator plane 34, the mirror array plane 32 includes a tiltable MEMS mirror and the collimator plane 34 includes a port or collimator for receiving a light beam. The optical connections 28 connect to the port or collimator and the electrical connections 30 connect to the MEMS mirror. FIG. 6 is a close-up view of one end of the OCS showing one layer in the 2D stack of input/output and mirror elements.

Note, the embodiment in FIGS. 5 and 6 is where the assemblies 10 oppose one another intermixing ports 14, the collimator plane 34, and mirrors, the mirror array plan 32.

The face on the front portion 12 where the mirrors are mounted could be angled in such a way that the flat reflection off the surface (the mirrors in their rest state and not being actively tilted) is pointed to the center of the opposing array. This is the direction which will couple to the other half of the switch array. Each element of the larger array is adjusted to a nominal angle creating a piecewise curved surface 36 which forms an approximate piecewise paraboloid surface. The piecewise paraboloid surface is much simpler to achieve than typical aspheric lenses or mirrors which need to be ground to a non-spherical shape. Of course, one could also simplify the design by following a portion of a sphere when the distances allow for the misalignment within the tolerances of the control angles of the mirrors.

Each completed stack would then be used with an identical second stack arranged so that the flat faces of the mirror arrays face each other corresponding to the left and right halves of FIG. 5. In this example, an average tilt angle of 3.9 degrees is chosen to minimize the maximum tilt angles used in MEMS mirrors. This allows each mirror element in one plane to address all others in the other so that any input can be directed to any output. The main mechanical assembly can have a size of 33 cm×120 cm excluding the space needed for optical fiber and electrical connections. The width of 33 cm is set by the width of the input, output and mirror planes of 16.7 cm. The length of 120 cm is set by the limit of the tilt angle achieved by the mirrors, in this case ±4 degrees. The vertical dimensions of the box would be approximately the same as the height of the input planes, approximately 13.5 cm. The overall propagation distance of the light is approximately 365 cm.

### Active Alignment

Again, the present disclosure contemplates various different arrangements of the subassemblies 10, e.g., the N or W shapes. A key aspect of any arrangement with the modular subassemblies 10 is the ability to support active alignment of all of the collimators (ports 14) on the input/output stages and the mirrors 14 on the intermediate stages. The following describes active alignment of the mirrors 14.

FIG. 7 is a logical diagram illustrating an example connection from an input array 40, to a first mirror array 42, to a second mirror array 44, to an output array 46. Each array 40, 42, 44, 46 can be a subassembly 10, including the probe ports 14, labeled as T₁-T₄, U₁-U₄, V₁-V₄, W₁-W₄.

The opposing subassemblies 10 with the arrays 40, 42, 44, 46 need to be substantially co-aligned. In the following description, the terms arrays mean a collection of the sub-assemblies 10 and planes mean the front portion 12. For an array of input/output optics, this means that all of the elements of that array propagate in the same direction within an acceptable tolerance. This tolerance could be set by the targeting accuracy of the beam spots on a co-designed mirror array set at the appropriate distance. For example, centered within some fraction of the radius of the mirror such that a double bounce in the final configuration results in beam coupling between the input and output with acceptable loss. In this way, it is only the adjustment of the angle of the plane of the subassembly array that is required to guarantee alignment. Angular alignment of the input and output planes 40, 46 can be partially compensated by the tilt corrections in the mirror plane 42, 44 such that passive alignment of the input, output subcomponents is less critical during manufacturing.

For the mirror arrays 42, 44, co-alignment implies that the mirrors have a constant angular relationship to the plane of the array at any specific drive voltage. This allows a predictable offset in the drive voltage to the mirrors of the array to correct for angular deviations caused by manufacturing tolerances and mechanical perturbations during operation.

It should be obvious to those skilled in the art that the optical cross-connect 20 described herein is not inherently directional, i.e., any optical port can be used as an input or an output or as a bidirectional port where light flows in both directions simultaneously. The device is also wavelength agnostic to the extent that the collimators and mirrors act withing a range of performance that results in acceptable loss and crosstalk. For example, it is anticipated that a single device could operate over multiple transmission bands used in telecommunications, for example, O, S, C, L and U bands.

The relative alignment of the mirror planes 42, 44 can be compensated by a feedback controller described below. It should be noted that the method of dithering component positions or angle is applied here as a part of a system designed to employ it and using a path through the optical setup not used for carrying the signal light itself as is usually implemented, i.e., the probe ports 16. One of the benefits of this implementation is that the dither can be large so as to provide a high second harmonic feedback signal which is not possible when used in the signal path elements without imparting a large Insertion Loss (IL) dither on the signal passing through. See, e.g., Goodwin, “Dynamic Alignment of Small Optical Components” Journal of Lightwave Technology, VOL. LT-5, NO. 1, January 1987.

### Active Alignment of Input and Output Planes

The alignment of the input and output planes 40, 46 determined the centering of the beams on the mirrors. If this can be achieved passively, that is preferred, however, it may be necessary to provide a means of adjusting or controlling the two tilt axes of these planes. To do so, it would be advantageous to include at least one additional collimator on the input/output submodule and an equal number of quadrant detectors on the mirror plane such that alignment can be measured. Adjusting the tilt axes could be a manufacturing time process wherein the alignment is measured and then fixed using a process like welding, trim and set screws, bonding, adhesive, etc. When using active control feedback, one would use an actuator to adjust the tilt, like a piezoelectric actuator, motor control, etc.

### Probe Path Dither Control System

Starting with an OCS 20 which is arranged in multiple planes 40, 42, 44, 46, being the input plane, output plane, and mirror planes. Traditionally, these OCSs 20 are assembled from the inside out where the mirror planes 42, 44 are fixed to an optical bench and then the input and output planes are aligned with multiple planes already in place such that the entire assembly can be fixed in place. This approach has been reasonable given the size of OCSs currently on the market. These OCSs typically have 10's up to a few 100's of ports.

However, the market is demanding OCSs an order of magnitude bigger, e.g., having more than 1000 ports in one device. A new approach to alignment is required. Furthermore, the use of an optical bench, which is required for fixed, passive alignment limits the propagation of the light to the area above the plane of the bench, further limiting the expansion of the OCS in terms of port count.

The present disclosure provides a different approach to the assembly of OCSs 20 by breaking up the alignment into modular self-referenced planes 40, 42, 44, 46 and then adding a feedback control system to eliminate the need for an optical bench.

The planes 40, 42, 44, 46 are each designed to be assembled, aligned, and calibrated separately, such that the optical elements are aligned to each other in the plane with respect to a stable substrate mounted in the direction substantially perpendicular to the propagation of the light. This provides a degree of mechanical stability in these planes which can be used to guarantee alignment over time and temperature.

There are many concerns in aligning an OCS. The two main jobs are:

(1) Aperture alignment: Align the input and output planes 40, 46 such that the beams are relatively centered on the next plane of mirrors.

(2) Angular alignment: Align the mirrors to each other such that the tilt angles direct the beams from the input fiber to the out fiber with acceptable loss.

Aperture alignment is less sensitive to angular errors than the angular alignment step. The compounding factor with angular alignment is that one needs to be able to predictably control the mirrors in pairs to accurately direct the light between arbitrary pairs of ports.

The present disclosure provides an approach to substantially guarantee inter-element alignment stability such that the job of alignment of the entire OCS 20 is to compensate for the angular alignment of the planes 40, 42, 44, 46 with respect to each other. This allows the planes 40, 42, 44, 46 to be roughly aligned with respect to each other in assembly and then use a control loop to compensate for the angular alignment of each plane with respect to each other.

The present disclosure assign n ports as active alignment ports, i.e., the probe ports 16. In this example, there are 4 ports arranged at the edges of the input and output arrays 40, 46. As few as 1 may be sufficient if compensating only for the unknown tilt of a fixed flat mirror plane 42, 44 like a MEMS substrate or other fixed arrangement where individual mirrors have been calibrated to a fixed flat surface.

In an elliptical arrangement, the probe ports 16 could be at the outside of the ellipse along its perimeter, perhaps outside the useful collimator area, dispersed in angle around the center the ellipse.

Each probe port 16 input can be connected to a laser source which we refer to as a probe or alignment signal. The laser from the laser source may be partially modulated with a fixed modulation percentage as a way to provide accurate power and unique identification even when using Alternating Current (AC) coupled transimpedance amplifier detectors. Each alignment signal is routed through corresponding mirrors in the m mirror planes where m=2 in this example, in FIG. 7.

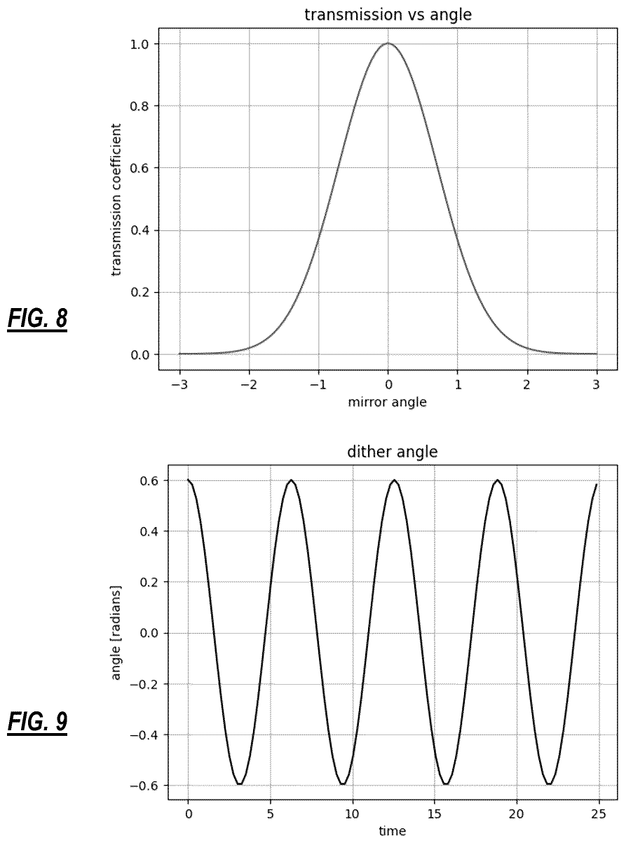

Each alignment mirror is driven with a sinusoidal drive of a different frequency for each of tilt axis of each mirror. Using two, two-axis gimbal mirrors would require four frequencies. A receiver is connected to the output of the fiber collimator at the output plane 46 of each probe port 16 which detects the alignment signal. The transmission coefficient of the signal path depends on the alignment angle of each axis of each mirror as shown in FIG. 8. Next, a sinusoidal dither is applied to the axes of the mirrors. For simplicity, a single axis of dither is shown in FIG. 9.

Imparting a sinusoid to the angle produces a time varying signal which at the receiver which contains:

(1) For an aligned mirror: large Direct Current (DC)+zero fundamental+large second harmonic.

(2) For a misaligned mirror: smaller DC+large fundamental+smaller second harmonic.

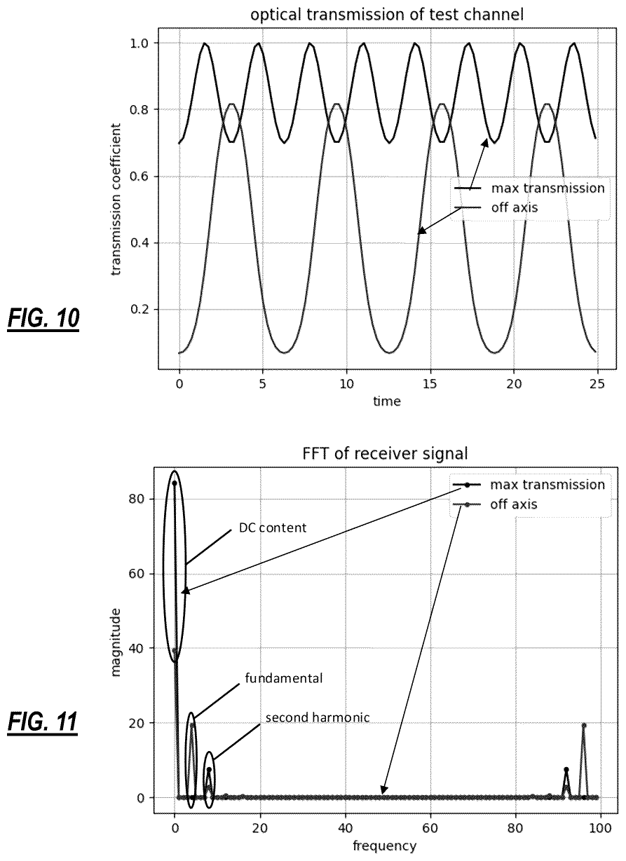

In addition, the phase of the fundamental with respect to the drive indicates which direction the correction for misalignment should be. These two conditions are shown in FIG. 10. To further analyze this signal, a Fourier transform is applied using the Fast Fourier transform (FFT) method well known in signal processing. These results are shown in FIG. 11.

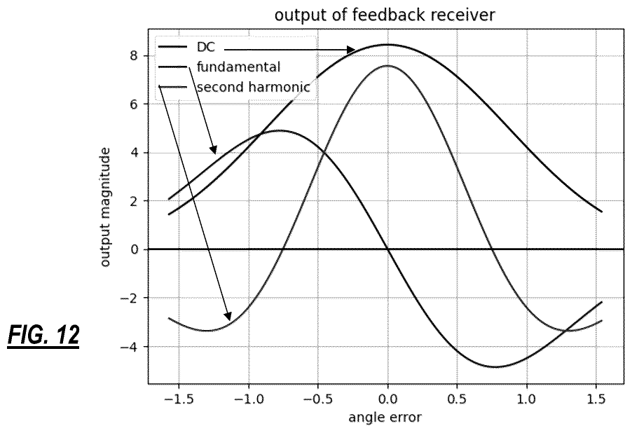

The feedback signals for the control system are derived from the frequency domain, selecting the points corresponding to the average power (so called DC or zeroth frequency point in the FFT), the fundamental (the frequency of the dither) and the second harmonic (2× the frequency of the dither). These points are shown in FIG. 12. Plotting these points over the possible angles of the mirror being controlled we can see how each point varies with the alignment of the mirror.

The control system adds an offset to each angle of each mirror with a target of minimizing the fundamental and maximizing the second harmonic. Combining these two, one can generate the feedback metric to minimize as follows:

$$error = ( amplitude of fundamental ) / ( amplitude of second harmonic )$$

This offset is then applied to the remaining mirrors to correct for their relative alignment with respect to the calibration of the plane.

### Control Accuracy for MEMS Mirrors

The requirement for accuracy is the ability to couple from fiber to fiber with low loss. Assuming the control system is capable of finding the center of each mirror and collimator, how much granularity is required to achieve the setting.

| Pointing accuracy calculation | Value | Units |
|---|---|---|
| Position error | 1% | |
| Mirror/collimator size | 1.8 | mm |
| Allowable offset distance | 0.018 | mm |
| Offset to angle | 2.11 | mm/deg |
| Allowable angle offset | 0.01 | deg |
| Full drive angle | 4 | deg |
| Fraction of full drive | 2.14E−03 | |
| Bits required | 8.87152 | |

A 12-bit Digital-to-Analog Converter (DAC) should be sufficient if the Effective Number of Bits (ENOB) including all non-idealities is >8.9 bits which is commonly achieved in practical circuits.

### Use Case

Those skilled in the art will recognize the OCS 20 and associated subassemblies 10 can be used in various applications, such as in a data center, providing optical switching in a spine network. Another application can include switching between Graphics Processing Units (GPUs). The boom in ML/AI training, specifically Large Language Models (LLMs) and other transformers, has resulted in the need for monstrous clusters of GPUs.

### Tolerance Analysis

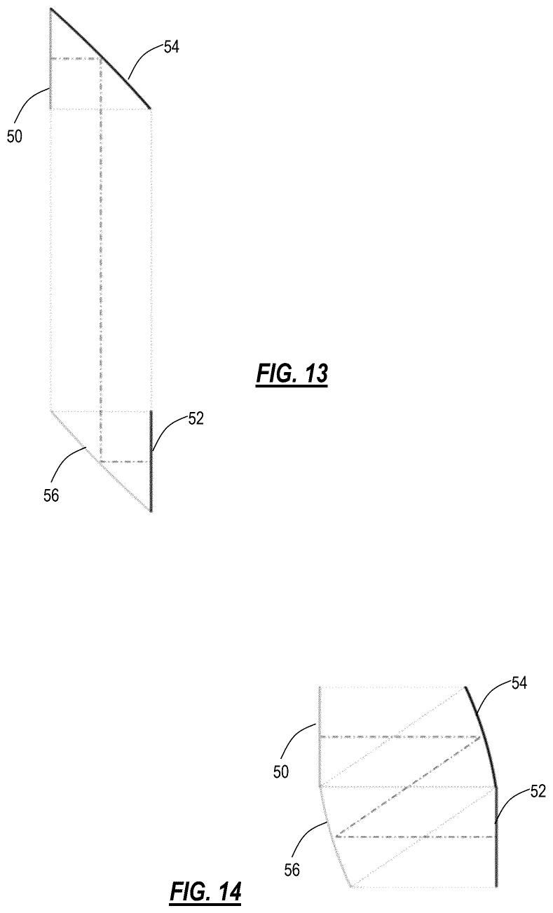

FIG. 13 is a diagram of a periscopic arrangement of collimators 50, 52 and mirrors 54, 56. FIG. 14 is a diagram of a compact arrangement of collimators 50, 52 and mirrors 54, 56. Here, the collimator 50 is the input collimator, the collimator 52 is the output collimator, disposed between the mirrors 54, 56. The periscopic arrangement maximizes distance between mirror arrays, which minimizes span of angular deviation of beams. The compact arrangement has much shorter distance between mirror arrays which results in much bigger span of angular deviation of beams.

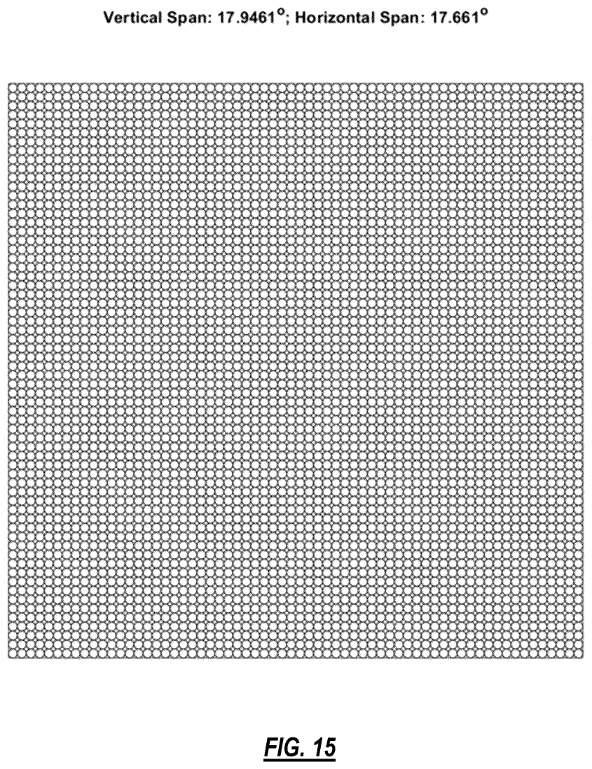

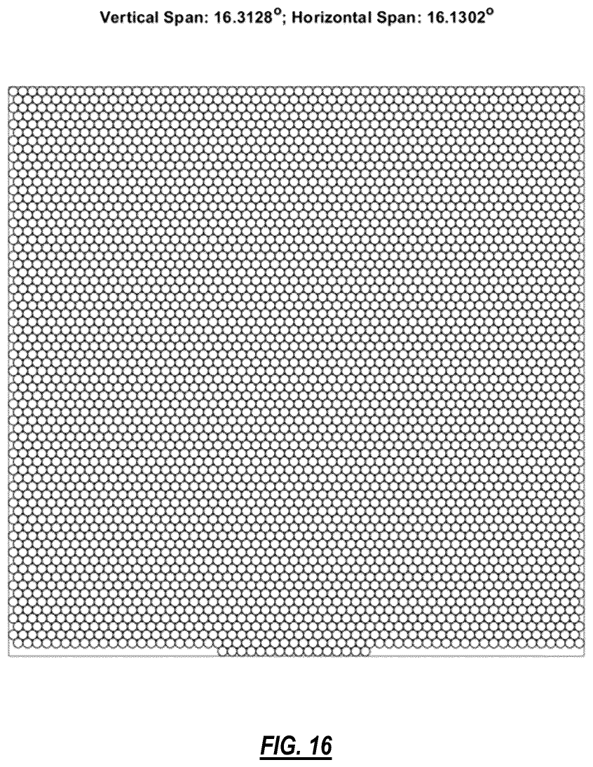

FIGS. 15 and 16 are diagrams of dense packing of collimators. Both FIGS. 15 and 16 include 4096 collimators each with a diameter of about 2.0 mm. In FIG. 15, the 4096 collimators are on a 64×64 square grid, and, in FIG. 16, the 4096 collimators re on a 68×60 hexagonal grid with 16 collimators on a bottom 69th row, to balance vertical and horizontal spans. The hexagonally packed collimators imply slightly smaller angular spans of beam deviation.

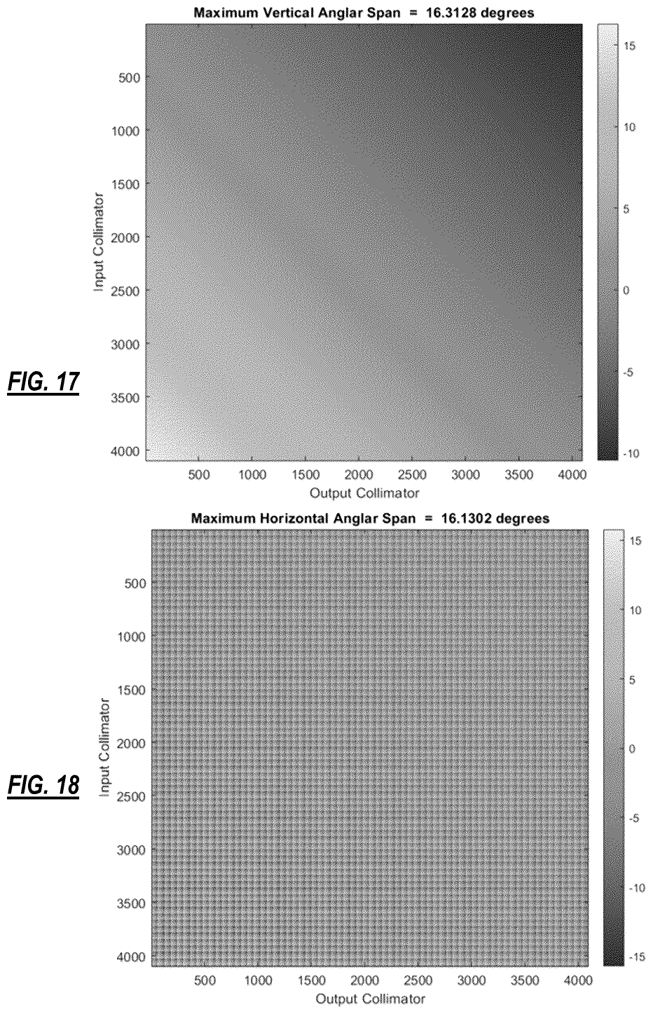

FIGS. 17 and 18 are graphs of vertical and horizontal angular deviation of beams for the hexagonal grid in FIG. 16. Vertical angular beam deviation depicted in FIG. 17 is zero for beams from input collimators 50 in each row being directed to output collimators 52 in the same row, as they are on top left to right bottom diagonal of the plot and color-coded as zero according to shading. FIG. 18 is a plot of horizontal angular beam deviation on the right is a mosaic of 4096 small plots similar to the one on the left.

The maximum angular deviation spans for collimators on both square (FIG. 15) and hexagonal (FIG. 16) grids can be achieved by any standard MEMS mirror with tilt angle swinging ±4.5° from nominal position. The problem is that mirrors on flat mounting base plate need to be mounted at an additional tilt to place their nominal position in the middle of the angular deviation span. This could be accomplished simply by mounting MEMS mirrors on inner the surface of a paraboloid, which would (with all mirrors at their nominal position) direct all collimated beams to its focal point at the center of the opposite paraboloidal mirror array. The resulting slightly curved shape of both mirror arrays is noticeable in FIG. 14.

This analysis is based on feasible 2.0 mm pitched collimator arrays at 640 mm distance. The same pitch for a diameter 2.0 mm MEMS mirrors is more problematic, which might require appropriate increase in pitch and subsequent increase in angular deviation spans, for example, doubling the pitch to 4.0 mm would require ˜47° angular deviation span, unless the distance between collimator arrays is increased in the same proportion.

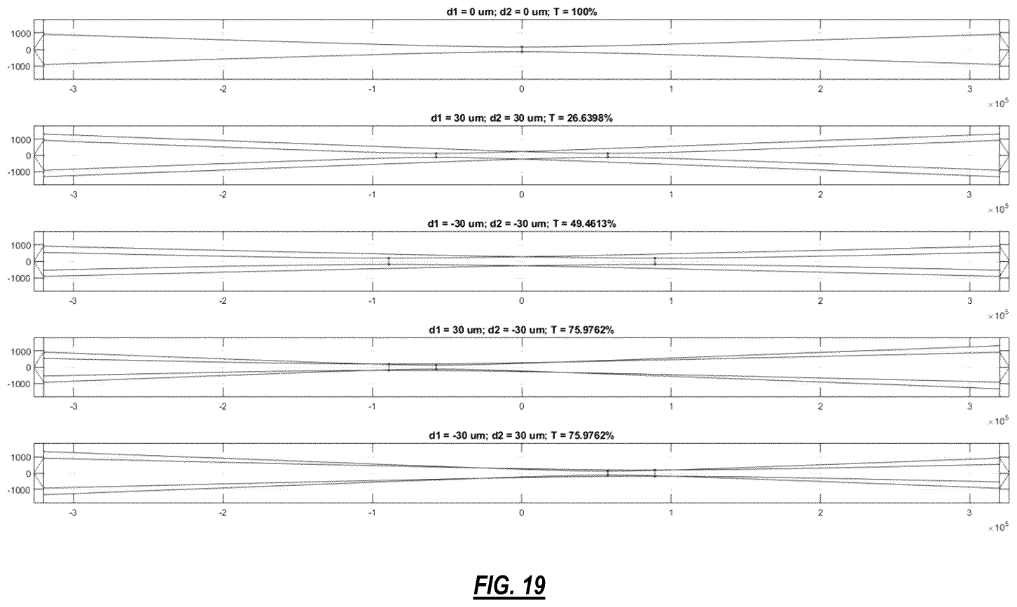

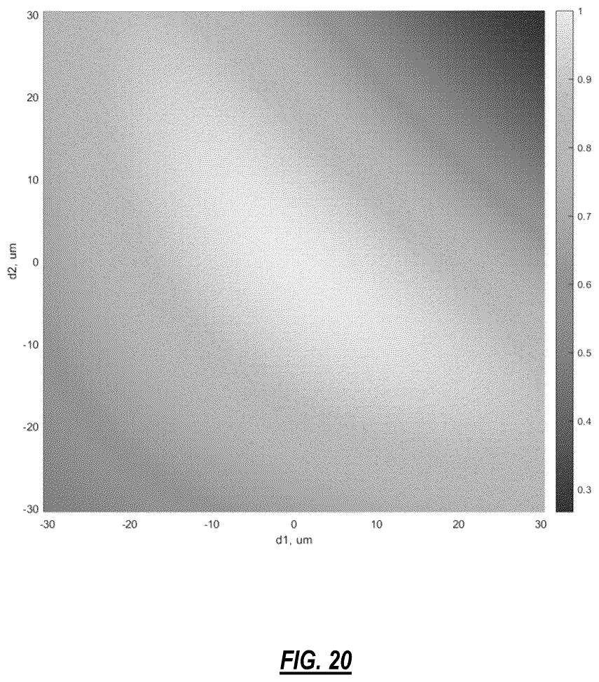

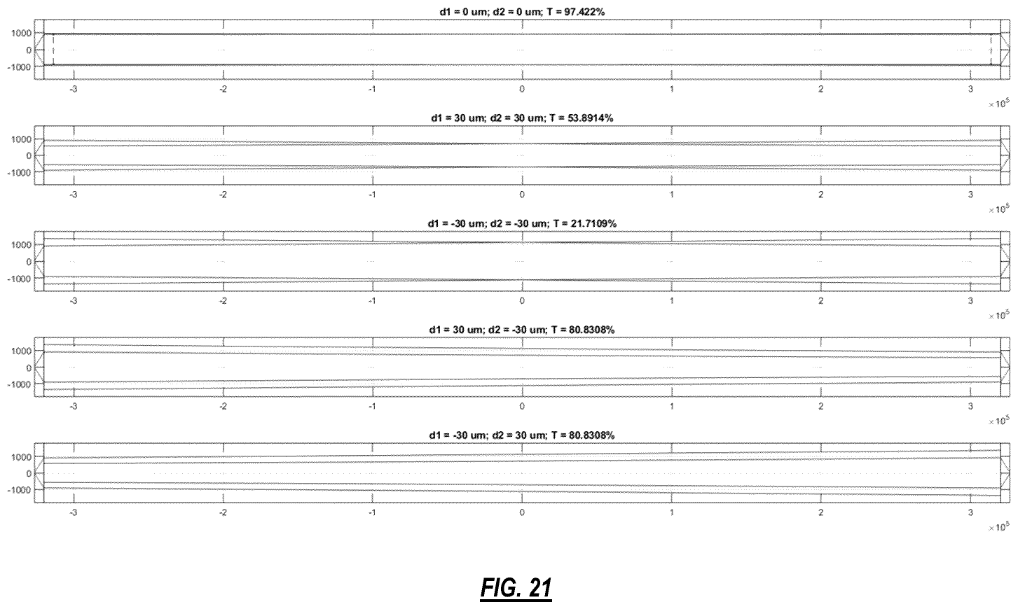

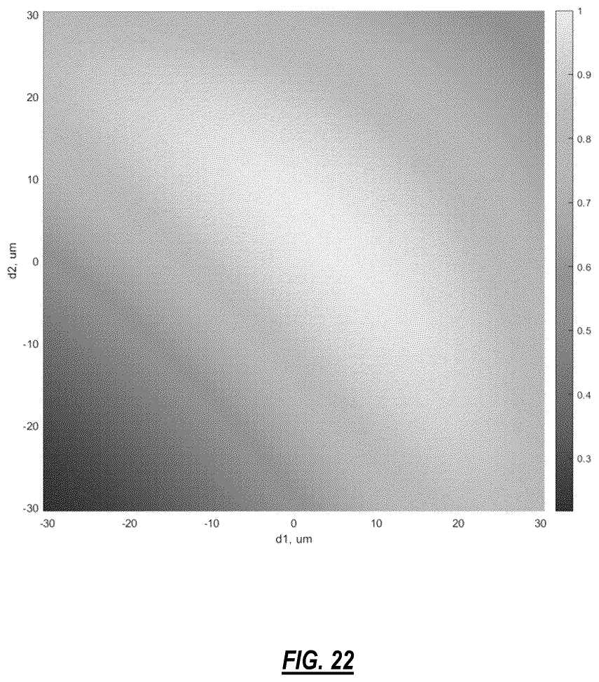

FIGS. 19 and 20 are graphs of coupling efficiency of 1320 nm light in confocal pair of diameter 2.0 mm focusers at 640 mm versus deviations d1 and d2 from prescribed distance between fiber faces and lenses. FIGS. 21 and 22 are graphs of coupling efficiency of 1320 nm light in pair of diameter 2.0 mm collimators at 640 mm versus deviations d1 and d2 from prescribed distance between fiber faces and lenses.

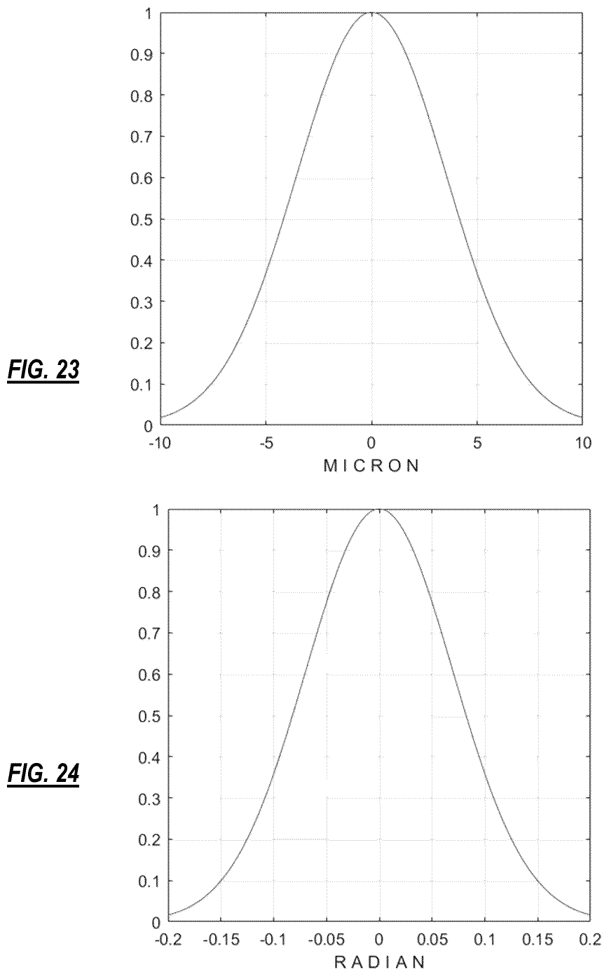

FIGS. 23 and 24 are graphs of coupling efficiency of two 1320 nm Gaussian beams with beam radius wₒ=3 μm versus lateral displacement (FIG. 23) and angular misalignment (FIG. 24). Angular inclination of collimated beam incident on collimating lens is obtained from lateral displacement by dividing it by focal length of the collimating lens. Off-axis displacement of collimated beam incident on collimating lens is obtained from angular misalignment by multiplying it by focal length of the collimating lens.

### Optical Cross Connect

In an embodiment, an optical cross connect 20 includes a plurality of subassemblies 10 each including one or more of an array of collimators 50, 52 and an array of adjustable mirrors 54, 56, wherein the plurality of subassemblies 10 are configured to modularly scale a size of the optical cross connect, wherein arrays of adjustable mirrors 54, 56 are arranged opposing one another with an optical propagation region 22 in between, and wherein the array of collimators 50, 52 includes one or more probe ports 16 configured to support an alignment signal for active alignment control.

Each of the plurality of subassemblies 10 can include a housing 18 supporting the array of collimators 50, 52 and the array of adjustable mirrors 54, 56, and the housing 18 includes electrical connectors 30 to the array of adjustable mirrors 50, 52 and optical connections 28 to the array of collimators 50, 52. The plurality of subassemblies 10 can include a first set of subassemblies and a second set of subassemblies opposing the first set of subassemblies with the optical propagation region 22 in between. Each subassembly of the plurality of subassemblies 10 can include a number of collimators 50, 52 and a number of adjustable mirrors 54, 56, such that an overall size of the optical cross connect is based on a number of the plurality of subassemblies 10. The number of adjustable mirrors 54, 56 can include redundancy where some of the adjustable mirrors are unused.

The array of collimators 50, 52 and the array of adjustable mirrors 54, 56 can be such that each collimator is disposed next to a corresponding mirror, with the mirror in a curved plane relative to the collimator. Each subassembly 10 of the plurality of subassemblies can include a front portion 12 having the array of collimators 50, 52 and the array of mirrors 54, 56 thereon. The active alignment control can include compensating for angular alignment between two different subassemblies 10 each with the array of mirrors 54, 56, such that tilt angles support an acceptable loss between two collimators 50, 52. The one or more probe ports 16 can include at least three ports at edges of the array of collimators 50, 52.

The active alignment control can include a laser connected to a probe port 16 on a first array of collimators 50 and configured to transmit the alignment signal; a receiver connected to a probe port 16 on a second array of collimators 52 and configured to receive the alignment signal, after the alignment signal traverse a pair of mirrors 54, 56; and circuitry configured to measure angular offsets of the pair of mirrors 54, 56. The circuitry can be further configured to apply a dither to the pair of mirrors 54, 56, measure the alignment signal at the receiver over time based on the dither, and determine feedback for the pair of mirrors 54, 56 based on the measured alignment signal. The circuitry can be further configured to measure the angular offsets of the pair of mirrors 54, 56 in two different arrays of adjustable mirrors, and cause adjustment of all mirrors in the two different arrays of adjustable mirrors based on the measured angular offsets of the pair of mirrors 54, 56. The size of the optical cross connect can be at least 1000 ports.

### Process

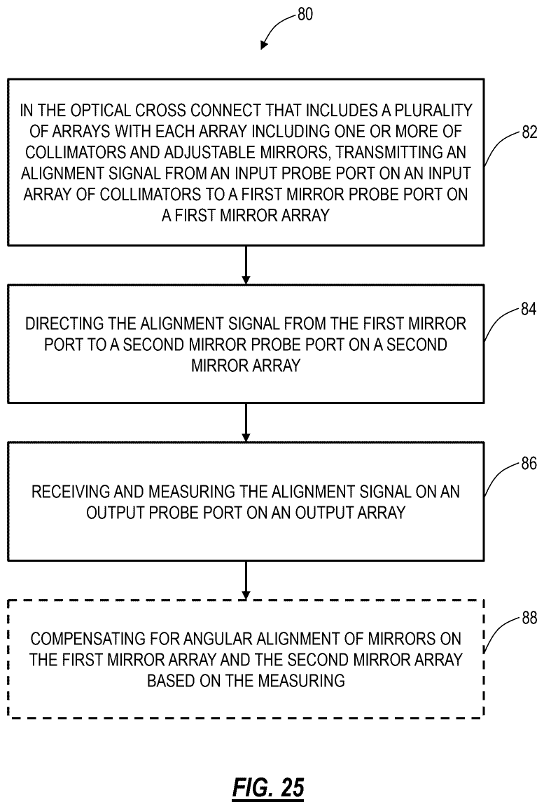

FIG. 25 is a flowchart of a process 80 of aligning an optical cross connect 20. The process 80 includes, in the optical cross connect that includes a plurality of arrays with each array including one or more of collimators and adjustable mirrors, transmitting an alignment signal from an input probe port on an input array of collimators to a first mirror probe port on a first mirror array (step 82); directing the alignment signal from the first mirror port to a second mirror probe port on a second mirror array (step 84); and receiving and measuring the alignment signal on an output probe port on an output array (step 86). The process 80 can also include compensating for angular alignment of mirrors on the first mirror array and the second mirror array based on the measuring (step 88).

The process 80 can also include applying a dither to the first mirror port and the second mirror port; measuring the alignment signal over time based on the dither; and determining feedback for mirrors on the first mirror array and the second mirror array based on the measured alignment signal. The dither can be sinusoidal, causing different characteristics in the received alignment signal based on whether or not the first mirror port and the second mirror port are aligned.

The process 80 can also include measuring angular offsets of first mirror probe port and the second mirror probe port; and causing adjustment of all mirrors in the first mirror array and the second mirror array based on the measured angular offsets. The input array of collimators and the output array of collimators each can include at least four ports at edge collimators. The optical cross connect can include a plurality of subassemblies each including an array of collimators and an array of adjustable mirrors.

### Example Arrangements

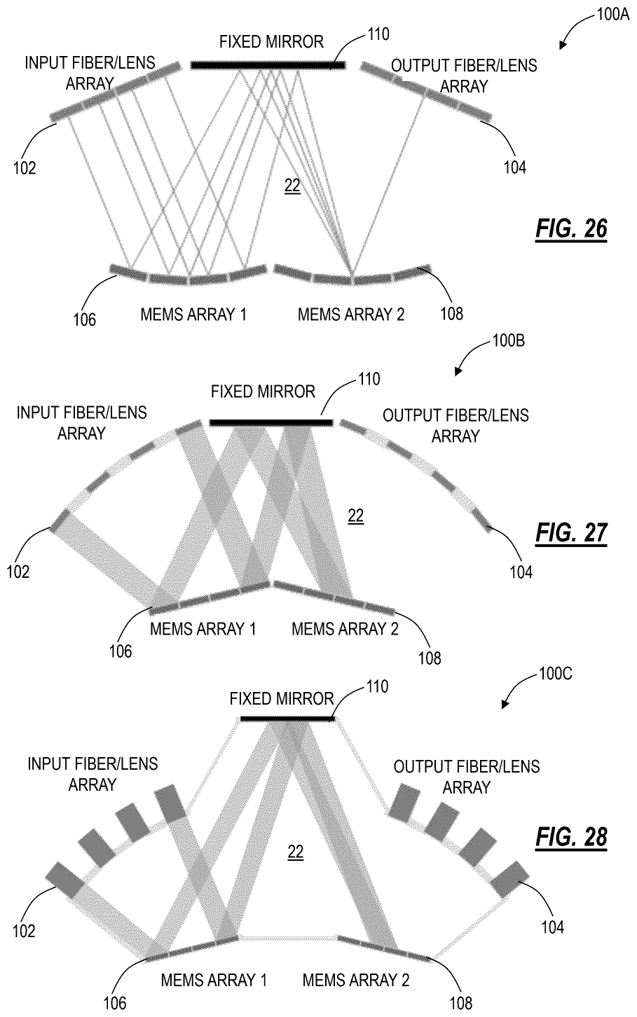

FIGS. 26-28 illustrates three different arrangements 100A, 100B, 100C of input/output arrays 102, 104, MEMS arrays 106, 108, and fixed mirrors 110, arranged relative to one another with the optical propagation region 22. All of FIGS. 26-28 are top views, looking down on the optical propagation region 22, illustrating arrangement of the arrays 102, 104, 106, 108 and the fixed mirrors 110. Of note, this corresponds to the =W′ architecture. Each of the arrays 102, 104, 106, 108 can include one or more of the subassemblies 10, e.g., the arrays 102, 104 being subassemblies 10 with the ports 14 (collimators) and the arrays 106, 108 being subassemblies 10 with the mirrors 14. Again, the size of the different arrangements 100A, 100B, 100C can be based on the number of subassemblies 10. Further, the subassemblies 10 can be mounted in a rack, chassis, shelf, etc., and are field replaceable. The fixed mirrors 110 can be fixed, namely mounted in the rack, chassis, shelf, etc., as well as being a third type of subassembly 10 that is field replaceable.

In each of the different arrangements 100A, 100B, 100C, each input/output array 102, 104 is a 2D arrangement of fibers and lenses. The view in the diagram is top down such that the fibers would be connected on the top of the gray planes in the diagram and the light leaves/enters the arrays 102, 104 on the faces which are facing toward the MEMS array 1 106 and MEMS array 2 108 respectively. The two dimensions of each fiber/lens array are vertical (out of the page) and horizontal (along the face of the plane as drawn).

The arrangement 100A includes semi-parabolic planes for the MEMS arrays 106, 108. The arrangement 100B includes semi-parabolic planes for the input/output arrays 102, 104, providing more space for mechanically adjustable input/output arrays 102, 104 (discussed herein). This also results in the MEMS arrays 106, 108 having a single tilt angle which will help packaging them together. The arrangement 100C includes moving the MEMS arrays 106, 108 apart to allow longer propagation between them.

### Port Alignment Mechanism

In addition to mirror alignment described above, another challenge in creating MEMS-based free-space optical devices, especially those with many input and output fibers, is the bulk alignment of the input/output collimators to the MEMS arrays. The relative alignment of the MEMS planes can be compensated for using test-ports and dithers, as described herein, however, this cannot be done for the input/output planes. In typical configurations, the alignment of the input to the first mirror plane and the output to the second mirror plane is just as critical as the mirror-to-mirror alignment. However, it is not an angular problem, it is aligning the spots to the mirrors and how that is maintained over life.

The normal solution to the problem of input/output alignment is to do careful alignment and measurements during the manufacturing phase. The entire optical chain is assembled but not fixed in place. Position and angular control stages are used to move the input and output planes in a search pattern to find the optimal coupling from end to end of the optical system. This is a multi-step process which is iterative, i.e., when one portion is close to optimal, the next portion is moved closer to its optimal and back and forth in such a way that the overall system is optimized. Then the components are fixed in place through welding or adhesives being cured and the system allowed to relax. Any further movement is potential degradation of the optical performance and must be guarded against in the specification of the device and by careful mechanical design with additional components provided for rigidity, temperature compensation, etc.

In the different arrangements 100A, 100B, 100C, examples of light beams are shown leaving the input fiber/lens arrays 102, 104 and heading toward the MEMS arrays 106, 108. For each input fiber there is a corresponding MEMS mirror element. To couple with low loss, the light from each input must strike the MEMS mirror in the middle without spilling over the edge.

The present disclosure solves this problem by active alignment using an alignment feature on the MEMS device, described above, and using corresponding probe port in the input and output arrays 102, 104, described as follows.

### Detectors on the MEMS Devices

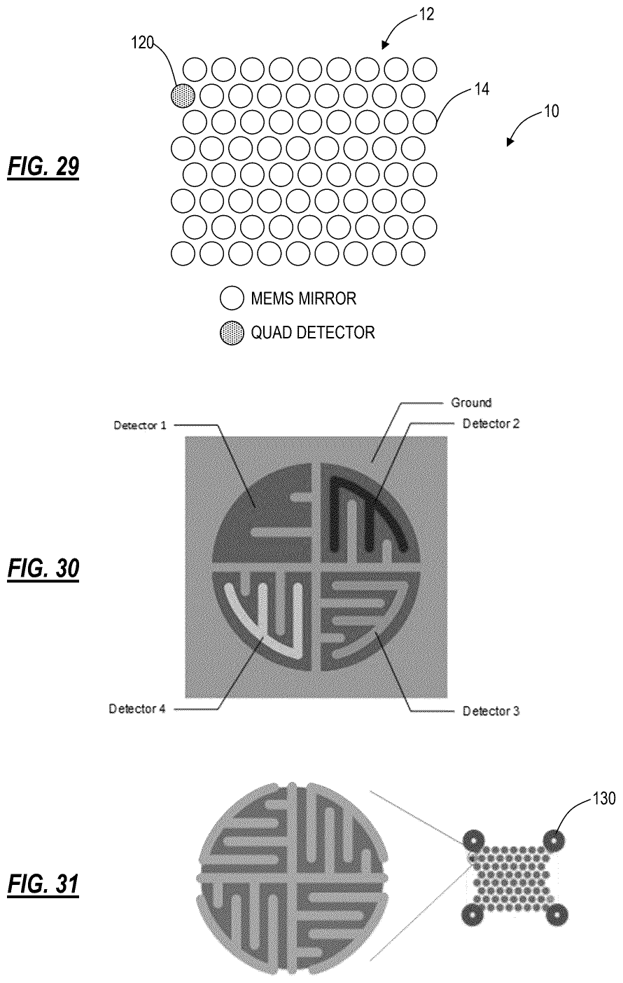

FIG. 29 is a front view of the subassembly 10 illustrating a front portion 12 having MEMs mirrors 14 and a quad detector 120. FIG. 20 illustrates the subassembly 10 front portion 12 for the input and output arrays 102, 104. In particular, the present disclosure includes integrating quadrant detectors 120 on the MEMS devices themselves. The quadrant detectors 120 are the so-called Metal-Semiconductor-Metal (MSM) type of photodetector manufactured directly on a silicon substrate. This would replace one of the mirror locations with a quadrant detector 120 as shown in FIG. 29.

The normal challenge with photodetectors on silicon substrates is that the material is transparent to the wavelengths typically used in communications systems, e.g., at 1500 nm, or 1310 nm. As such, the present disclosure has the photodetector (for the quadrant detector 120) operate at 850 nm, or any wavelength in the absorption/detection band of intrinsic silicon. In this way, the quadrant detector 120 is compatible with the normal processes used to manufacture the MEMS elements, i.e., the MEMS mirrors 14. In fact, MSM photodiodes require only a metallization layer in a specified pattern, and connections to the detector electrodes rather than special materials or dopants. MSM detectors are often not used because of poor quantum efficiency due to the shadowing effect of the surface metal electrodes. However, this application does not require high responsivity and benefits from the tightly controlled geometry offered by the patterning of the electrodes making MSMs an ideal choice for this application.

FIG. 29 shows the corresponding input or output fiber/lens array which has a quadrant detector 120 port dedicated to 850 nm light. This port can be created using the same microlens and provided that a special fiber with single mode operation at 850 nm or the chosen wavelength for alignment is used for this port. So long as the 850 nm fiber has a numerical aperture (NA) close to that of the fiber/wavelength combination used for the traffic ports, and the material of the microlenses had a moderate material dispersion, the light from the 850 nm port will be substantially collimated like the traffic bearing ports. Even an imperfectly collimated beam will have an intensity pattern which can be used for alignment making the design insensitive to small deviations of the NA and focal length of the lenses.

FIG. 30 is a diagram of an example arrangement of the MSM quadrant detector 120 design. The MSM quadrant detector 120 includes four detectors approximately dimensioned the same as a MEMS mirror 14 on the front portion 12, on a ground layer metallization that is required to eliminate off-detector current generation. There can be an infrared (IR) cover to eliminate visible light.

Due to the substantially Gaussian beam intensity profile of the light in a collimated beam from a fiber, the light impinging on the quadrant detector 120 will be sensitive to the alignment of the light to the center of the detector. Essentially, by adjusting the angular and position alignment of the input/output planes to their corresponding MEMS array, the feedback from each of the four detectors of the quadrant detector 120 is maximized and equalized. This, in turn, guarantees good alignment.

It should be noted that the circuitry that each quadrant detector 120 is connected to must also provide a voltage bias. MSM photodetectors require a voltage bias to produce a current when the hole-electron pairs are produced in the bulk material. Without a bias, these hole-electron pairs recombine naturally, but in the presence of a bias voltage they are swept in opposite directions toward the electrodes and thereby produce a current proportional to the intensity of the detected light.

In addition, using an amplitude modulation on the probe signal could help differentiate the probe signal from background light that may be present. This modulation could be a specific frequency, or a special modulation code, for example, which would allow the detector circuitry to lock in on the signal of interest and filter out the background noise.

FIG. 31 is another arrangement with four quadrant detectors 120 at four corners of the matrix effectively forming a large, distributed quadrant PD shown at locations 130.

In one embodiment the control and feedback mechanisms are used during manufacturing for initial alignment. The alignment can be done independently for the input and output fiber arrays rather than the complex coupled process used when doing end to end alignment.

In another embodiment the feedback from the MSM detectors is used during operation. In this embodiment, the feedback is augmented with a means to control the angular alignment of the input/output arrays. Using the feedback alignment is maintained over life, temperature, and even vibration if the feedback and actuation path has sufficient bandwidth. Adjustment of the input/output angles could be achieved through piezoelectric actuation or other electro-mechanical means.

Mechanical Form Factor-Subassembly with Collimator Ports

Physically, the optical cross connect 20 is realized with a plurality of subassemblies 10, installed in the field, in a chassis, rack, shelf, etc. Again, each subassembly 10 includes the housing 18 which is field replaceable. Also, there can be different variants for the subassemblies 10, namely one for the input/output array 102, 104, and one for the MEMS array 106, 108. For alignment, the MEMS array 106, 108 with the corresponding MEMS mirrors can be adjusted as described herein. That is, there is an ability to control each MEMS mirror. For the input/output array 102, 104, the collimator ports are not adjustable as is a MEMS mirror, but for realizing a field upgradeable, modular optical cross connect 20, there is a need to provide active alignment on the entire path (see FIG. 7). That is, the collimator ports are fixed and not adjustable as is a MEMS mirror. However, the present disclosure includes a mechanical form factor that supports physical adjustment of its location as part of a larger optical cross connect 20 to support alignment of the collimator ports.

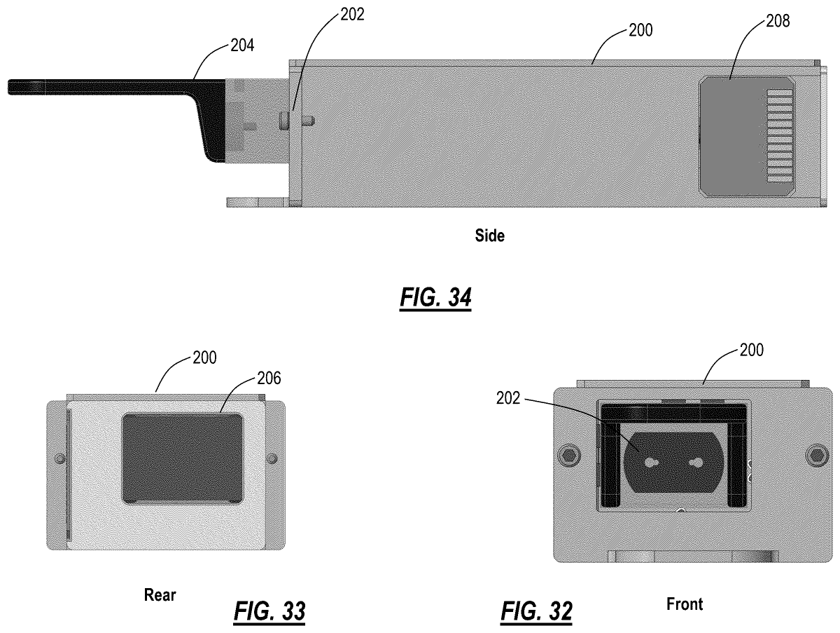

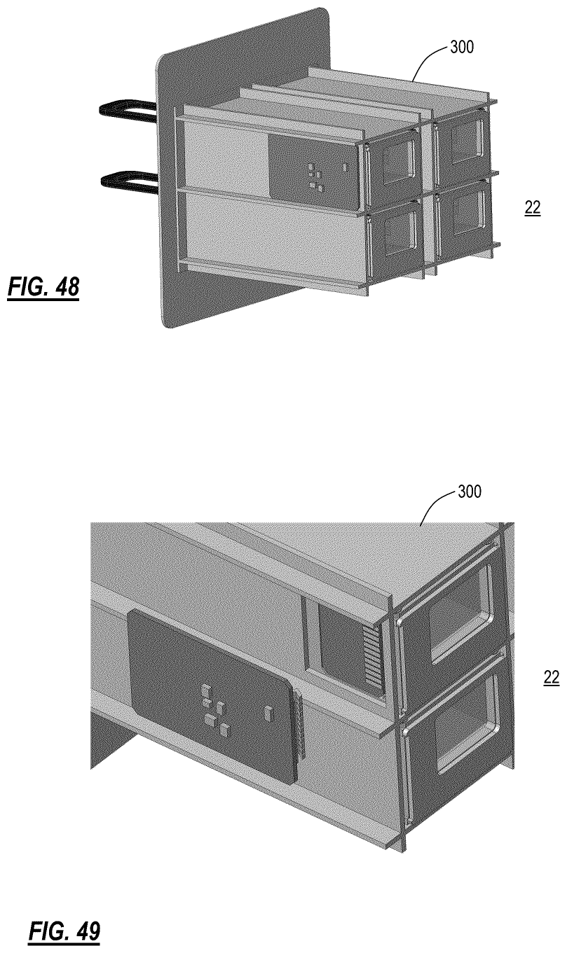

FIGS. 32-49 are diagrams of an example form factor 200 for a subassembly 10 with ports 14 for the input/output array 102, 104, where the form factor 200 includes alignment circuitry configured to align/adjust the front portion 12 based on the quadrant detector 120 feedback. That is, the object here is to slightly move the subassembly 10 to align the ports 14 on the front portion within a larger optical cross connect 20, based on the quadrant detector 120 feedback.

FIGS. 32-34 are front views (FIG. 32), rear views (FIG. 33), and side views (FIG. 34) of the form factor 200. The front view includes an interface 202 which connects to a cable assembly 204, containing a plurality of fibers for the ports 14. The fibers connect to an optical array 206 in the rear of the form factor 200, which is the front portion 12 facing the optical propagation region 22 of the optical cross connect 20. Of course, a practical embodiment of the optical cross connect 20 can include a plurality of the form factors 200, to expand the size as needed. The front portion and the interface 202 is visible to a user. Also, the form factor 200 can include a control Printed Circuit Board (PCB) for data and power connectivity within the optical cross connect 20. Here, this can provide power to the quadrant detector 120 and the alignment circuitry, as well as provide data feedback to the optical cross connect 20 based on the quadrant detector 120 and the alignment circuitry.

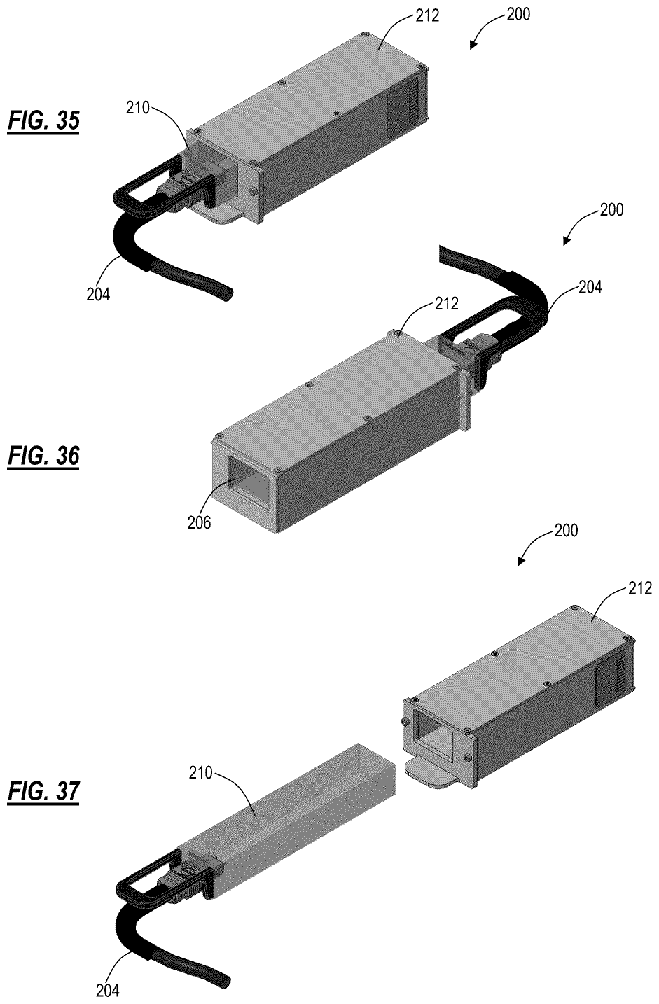

FIGS. 35-37 illustrate the form factor 200 with an optical module 210 and a housing module 212, in an example embodiment. FIG. 35 is a perspective view with the optical module 210 connected to the cable assembly 204 and included in the housing 212. FIG. 36 is an opposite perspective view from FIG. 35. FIG. 7 is a perspective view with the optical module 210 connected to the cable assembly 204 and removed from in the housing 212. In an embodiment, the optical module 210 latches into the housing 212, and both are Field Replaceable Units (FRU). In another embodiment, the optical module 210 is installed in or part of the housing 212, such that the optical module 210 is non-FRU, while the housing 212 with the optical module 210 included is FRU.

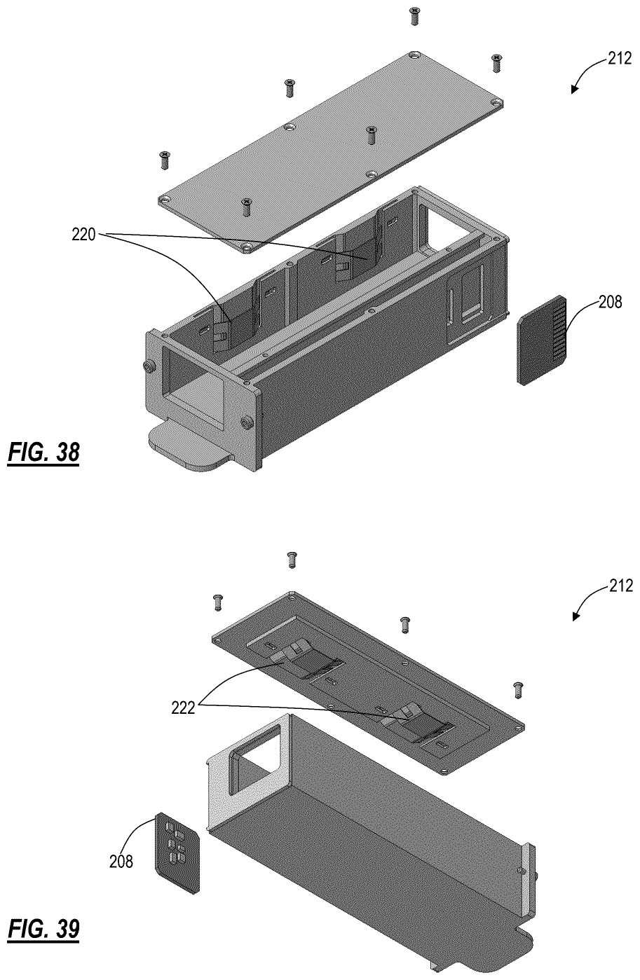

FIGS. 38-39 are two opposing exploded perspective views of the housing 212. The housing 212 includes horizontal plane springs 220 (shown in FIG. 38) and vertical plane springs 222 (shown in FIG. 39). The horizontal plane springs 220 and the vertical plane springs 222 are located in the interior of the housing 212 abutting the optical module 210 and configured to provide tension in either or both the horizontal and vertical planes, to provide slight spatial adjustment of the optical module 210, based on feedback from the quadrant detector 120. The terms horizontal and vertical plane are with respect to the optical propagation region 22. Thus, the horizontal plane springs 220 and the vertical plane springs 222 can be used to slightly move the ports 14 for collimator alignment.

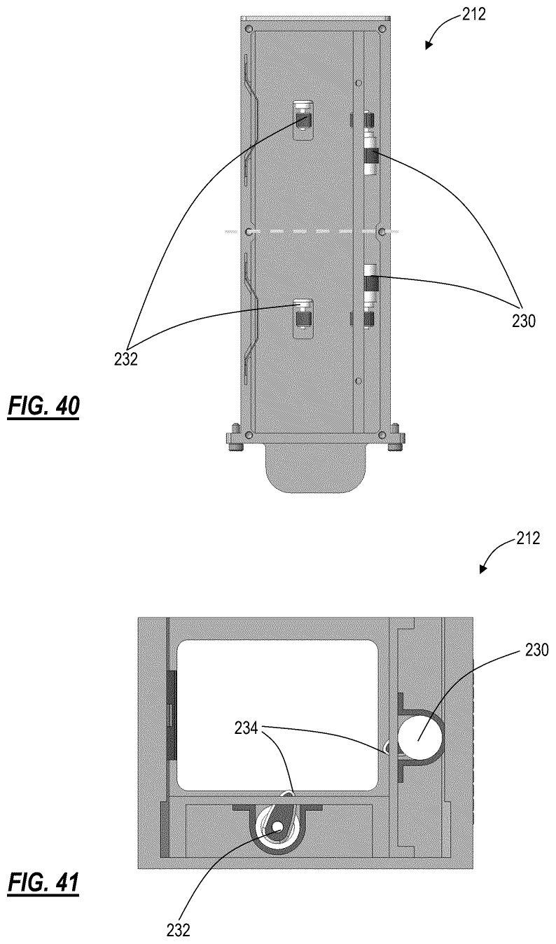

FIGS. 40-41 are a top view (FIG. 40) and a front cross-sectional view (FIG. 41) of the housing 212, illustrating alignment control via horizontal plane control 230 and vertical plane control 232. The horizontal plane control 230 and vertical plane control 232 can be any mechanical mechanism, such as a motor, hydraulic components, pneumatic components, etc. The horizontal plane control 230 and vertical plane control 232 each include actuator control points 234 which make contact with optical module 210 to apply a force thereto for alignment. The horizontal plane control 230 and vertical plane control 232 can each apply a force via the actuator control points 234, along with the horizontal plane springs 220 and the vertical plane springs 222, there can be active alignment control of the optical module 210 to provide slight movement of the ports 14.

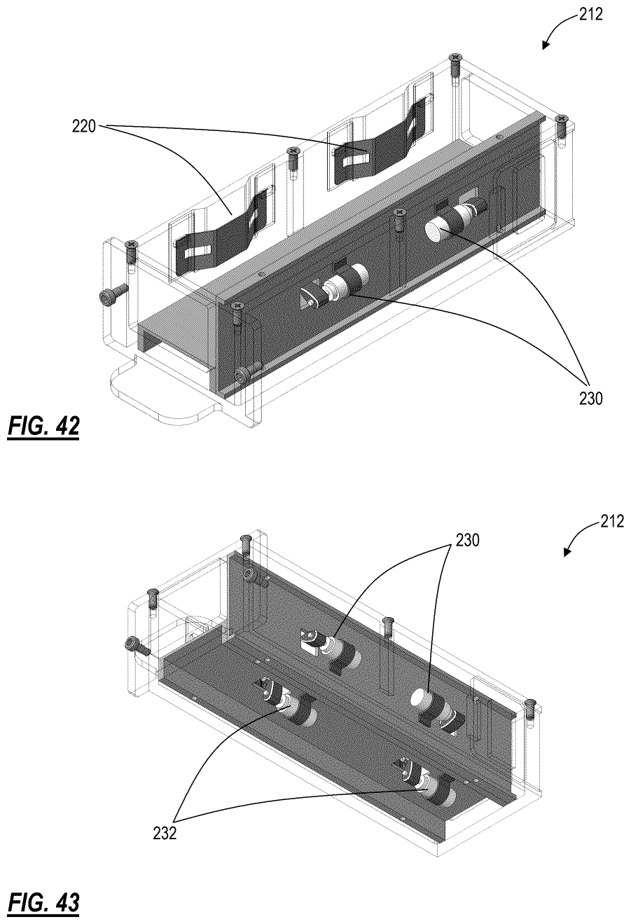

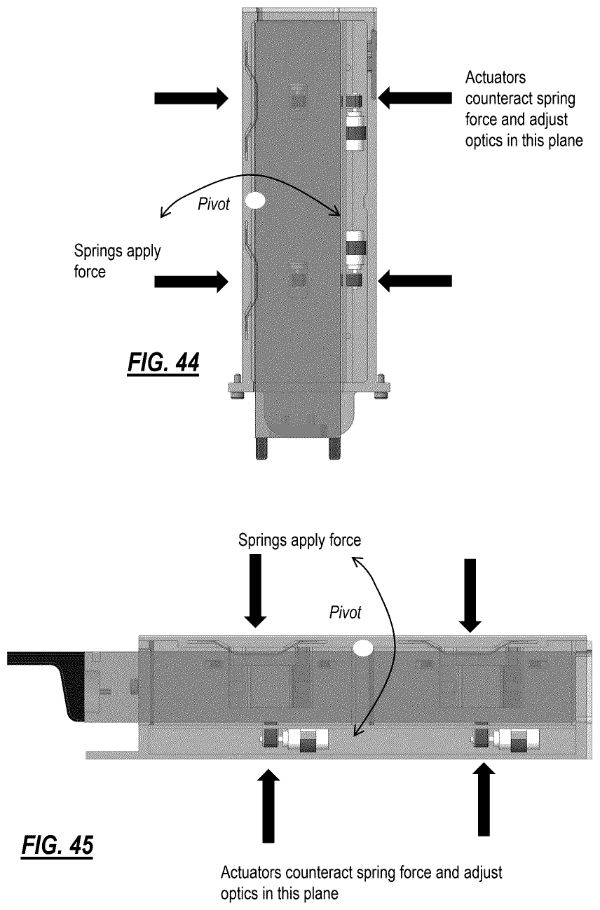

FIGS. 42-43 are two opposing wireframe perspective views of the housing 212, illustrating the horizontal plane control 230 and vertical plane control 232 and the horizontal plane springs 220. FIGS. 44-45 are a top view (FIG. 44) and a side view (FIG. 45) of the housing 212 illustrating application of force for active alignment.

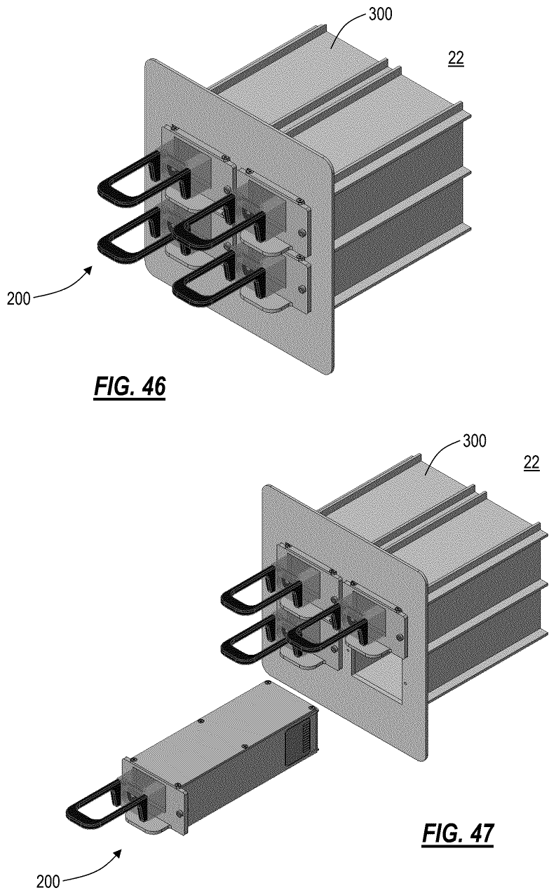

FIGS. 46-49 are various perspective views of an assembly 300 that is part of an optical cross connect 20 that supports four of the form factors 200. Again, the form factors 200 are FRU within the assembly 300. In this example, there can be four assemblies 10 (FIG. 46) which can be removed (e.g., see FIG. 47 with one assembly removed therefrom). Of course, those skilled in the art will recognize various different sized assemblies 300 are contemplated. The assembly 300 is rack mounted or packaged in some manner in the optical cross connect 20.

Of note, the example form factor 200 looks and has a similar shape/size to pluggable optical modules. As is known in the art, pluggable optical modules are compact, hot-swappable devices used in networking hardware to enable data transmission over optical fiber. In a similar sense, the example form factor 200 can make a larger optical cross connect 20 based on various subassemblies 10 including subassemblies 10 with ports 14 in the form factor 200. Those skilled in the art will recognize there can be a similar form factor for the subassemblies 10 with MEMS mirrors 14. Thus, the optical cross connect 20 can be field installed and upgradeable based on the number of subassemblies 10 used.

### CONCLUSION

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), GPUs; Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. That is, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments. Also, in the claims, the terms “comprise,” “comprises,” “comprising,” “include,” “includes,” and “including” are intended to be non-limiting and open-ended. These terms specifically list essential elements or steps but do not exclude additional elements or steps. This applies even when a claim or series of claims includes more than one of these terms.

What is claimed is:

1. An optical cross connect comprising:
a plurality of subassemblies each including either an array of collimators and an array of adjustable mirrors, wherein the plurality of subassemblies are configured to modularly scale a size of the optical cross connect,
wherein the plurality of subassemblies are arranged relative to one another with an optical propagation region in between, and
wherein the plurality of subassemblies with the array of collimators each include one or more probe ports configured to support an alignment signal for active alignment control.

2. The optical cross connect of claim 1, wherein each of the plurality of subassemblies with the array of adjustable mirrors include one or more detectors included in the array of adjustable mirrors, in lieu of a corresponding adjustable mirror.

3. The optical cross connect of claim 1, wherein each of the plurality of subassemblies include a housing supporting either the array of collimators and the array of adjustable mirrors, and the housing includes electrical connectors to the array of adjustable mirrors and optical connections to the array of collimators.

4. The optical cross connect of claim 3, wherein the housing supporting the array of collimators includes circuitry for physically alignment adjustments.

5. The optical cross connect of claim 1, wherein the plurality of subassemblies include a first set of subassemblies and a second set of subassemblies opposing the first set of subassemblies with the optical propagation region in between.

6. The optical cross connect of claim 1, wherein an overall size of the optical cross connect is based on a number of the plurality of subassemblies.

7. The optical cross connect of claim 6, wherein the number of adjustable mirrors includes redundancy where some of the adjustable mirrors are unused.

8. The optical cross connect of claim 1, wherein the plurality of subassemblies include a first set of subassemblies and a second set of subassemblies opposing the first set of subassemblies with the optical propagation region in between and with a fixed set of mirrors in the optical propagation region.

9. The optical cross connect of claim 1, wherein each subassembly of the plurality of subassemblies includes a front portion having either the array of collimators and the array of mirrors thereon.

10. The optical cross connect of claim 1, wherein the active alignment control includes compensating for angular alignment between two different subassemblies each with the array of mirrors, such that tilt angles support an acceptable loss between two collimators.

11. The optical cross connect of claim 1, wherein the one or more probe ports include at least three ports at edges of the array of collimators.

12. The optical cross connect of claim 1, wherein the active alignment control includes
a laser connected to a probe port on a first array of collimators and configured to transmit the alignment signal;
a receiver connected to a probe port on a second array of collimators and configured to receive the alignment signal, after the alignment signal traverse a pair of mirrors; and
circuitry configured to measure angular offsets of the pair of mirrors.

13. The optical cross connect of claim 11, wherein the circuitry is further configured to apply a dither to the pair of mirrors,
measure the alignment signal at the receiver over time based on the dither, and
determine feedback for the pair of mirrors based on the measured alignment signal.

14. The optical cross connect of claim 11, wherein the circuitry is further configured to
measure the angular offsets of the pair of mirrors in two different arrays of adjustable mirrors, and
cause adjustment of all mirrors in the two different arrays of adjustable mirrors based on the measured angular offsets of the pair of mirrors.

15. The optical cross connect of claim 1, wherein the size of the optical cross connect is at least 1000 ports.

16. A method of aligning an optical cross connect comprising steps of:
in the optical cross connect that includes a plurality of arrays with each array including one or more of collimators and adjustable mirrors, transmitting an alignment signal from an input probe port on an input array of collimators to a first mirror probe port on a first mirror array;
directing the alignment signal from the first mirror port to a second mirror probe port on a second mirror array; and
receiving and measuring the alignment signal on an output probe port on an output array.

17. The method of claim 16, wherein the steps further include compensating for angular alignment of mirrors on the first mirror array and the second mirror array based on the measuring.

18. The method of claim 16, wherein the steps further include
applying a dither to the first mirror port and the second mirror port;
measuring the alignment signal over time based on the dither; and
determining feedback for mirrors on the first mirror array and the second mirror array based on the measured alignment signal.

19. The method of claim 16, wherein the steps further include
measuring angular offsets of first mirror probe port and the second mirror probe port; and
causing adjustment of all mirrors in the first mirror array and the second mirror array based on the measured angular offsets.

20. The method of claim 16, wherein the input array of collimators and the output array of collimators each include at least three ports at edge collimators.
